(19) United States
(12) Patent Application Publication
(10) Pub. No.: US 2006/0206900 A1
(43) Pub. Date: Sep. 14, 2006

(54) Apparatus and program for controlling loads

(75) Inventors: Hiroyuki Ooyama, Kawasaki (JP); Yoshihiro Takahashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/174,508

(22) Filed: Jul. 6, 2005

(30) Foreign Application Priority Data
Mar. 10, 2005 (JP) 2005-067522

(51) Int. Cl. G06F 9/46

(52) U.S. Cl. 718/105

(57) ABSTRACT

A load control apparatus that enables a server to perform a process at a multiplicity most suitable for improving processing efficiency. A load information acquisition section acquires load information regarding loads on a CPU resource and other resources on the server. On the basis of the load information, a multiplicity determination section calculates an increase in load on each resource caused by increasing the multiplicity of the process which is being performed by the server, and determines a multiplicity by which a load on each of all the resources becomes smaller than or equal to an upper limit value set in advance. A multiplicity control section changes the multiplicity of the process which is being performed by the server to the multiplicity determined by the multiplicity determination section.

### CROSS-REFERENCE TO RELATED APPLICATIONS

This application is based upon and claims the benefits of priority from the prior Japanese Patent Application No. 2005-067522, filed on Mar. 10, 2005, the entire contents of which are incorporated herein by reference.

### BACKGROUND OF THE INVENTION

(1) Field of the Invention

This invention relates to a load control apparatus and load control program for controlling a load on a server and, more particularly, to a load control apparatus and load control program for controlling a load on a server by adjusting the multiplicity of processing.

(2) Description of the Related Art

Load control is exercised for efficiently operating large-scale computer systems. This load control includes overload control and underload control.

When a load is greater than a threshold (upper limit value), overload control is exercised to reduce the load to a value smaller than or equal to the threshold. When the load is smaller than the threshold, underload control is exercised to raise the load so that it will approach the threshold.

At present overload control is usually exercised. With overload control, the upper limit value of the load factor of each resource which users can use is set in advance, and a load on each resource is controlled so that it will not exceed the upper limit value.

For example, with a server computer which performs various processes in response to requests from terminal units, a plurality of server processes are started to handle the requests from the terminal units. The number of server processes simultaneously started is referred to as a multiplicity. In such a system, requests from a plurality of terminal units may be made in a specific period of time. In this case, a load factor in each server process rises. As a result, if the load factor in each server process exceeds a predetermined upper limit value, the server computer automatically increases a multiplicity. Increasing a multiplicity (increasing the number of server processes simultaneously performed) reduces a load in each server process. This prevents the processing load on the server computer from exceeding a predetermined load factor.

Systems in which overload control and underload control are exercised are also provided. For example, a technique for determining the usage of a central processing unit (CPU) in a server, and increasing a multiplicity in the server in the case of the usage of the CPU being greater than a preset upper limit value or decreasing the multiplicity in the server in the case of the usage of the CPU being smaller than the preset lower limit value is proposed (see Japanese Unexamined Patent Publication No. 2001-160040).

With the technique disclosed in the above Japanese Unexamined Patent Publication No. 2001-160040, however, processing loads on resources other than the CPU are not taken into consideration. Accordingly, even if the multiplicity of processing is increased at the time of a load on a resource other than the CPU being excessive, a load in each of processes performed in parallel may not be reduced.

That is to say, if business involving frequently performing an I/O (data input-output) process, such as access to a hard disk, is carried out, I/O processing capability is smaller than the CPU's processing capability. Even if the multiplicity of the processing is increased at the time of a processing load on a resource other than the CPU caused by carrying out the business exceeding an upper limit value, the CPU must wait for I/O. Because of such wait time, it takes a longer time to handle each piece of business. Therefore, efficiency in processing in the entire system is not improved.

### SUMMARY OF THE INVENTION

The present invention was made under the background circumstances described above. An object of the present invention is to provide a load control apparatus and load control program capable of making a server perform processing at a multiplicity most suitable for improving processing efficiency.

In order to achieve the above object, a load control apparatus for controlling a load on a server which performs multiplex processing is provided. This load control apparatus comprises a load information acquisition section for acquiring load information regarding loads on a CPU resource and other resources on the server; a multiplicity determination section for calculating, on the basis of the load information, an increase in load on each resource caused by increasing a multiplicity of a process which is being performed by the server, and for determining, on the basis of the load information, a multiplicity by which a load on each of all the resources becomes smaller than or equal to an upper limit value set in advance; and a multiplicity control section for changing the multiplicity of the process which is being performed by the server to the multiplicity determined by the multiplicity determination section.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 gives an overview of an embodiment of the present invention.

FIG. 2 shows an example of the system configuration of the embodiment of the present invention.

FIG. 3 shows an example of the hardware configuration of a performance management server used in the embodiment of the present invention.

FIG. 4 is a block diagram showing a function for managing performance.

FIG. 5 shows an example of the data structure of a performance information log.

FIG. 6 shows an example of the data structure of a load control object batch table.

FIG. 7 shows information regarding a CPU resource and an I/O resource included in a resource load management table.

FIG. 8 shows information regarding a communication resource included in the resource load management table.

FIG. 9 shows information regarding a process resource included in the resource load management table.

FIG. 10 is a flow chart showing the procedure for a load parameter setting process.

FIG. 11 shows an example of the data structure of a load simulation table.

FIG. 12 is a flow chart showing the procedure for an I/O load control process.

FIG. 13 is a schematic view showing processing capability which can be assigned to one batch process.

FIG. 14 is a flow chart showing the procedure for a communication load control process.

FIG. 15 is a schematic view showing the storage capacity of a communication buffer which can be assigned to one batch process.

FIG. 16 is a schematic view showing a multiplicity adjustment process.

FIG. 17 shows entire processing time taken if no interval is set.

FIG. 18 shows entire processing time taken if an interval is set.

### DESCRIPTION OF THE PREFERRED EMBODIMENTS

Embodiments of the present invention will now be described with reference to the drawings.

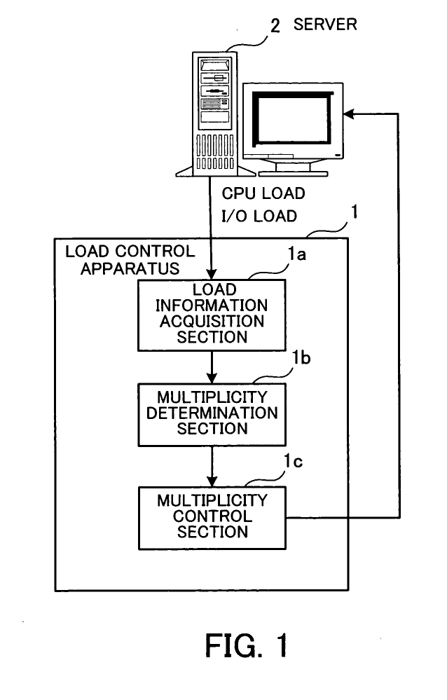

FIG. 1 gives an overview of an embodiment of the present invention. A load control apparatus 1 according to an embodiment of the present invention controls a load on a server 2 which performs multiplex processing. The load control apparatus 1 comprises a load information acquisition section 1a, a multiplicity determination section 1b, and a multiplicity control section 1c. The load information acquisition section 1a acquires load information regarding loads on a CPU resource and other resources (for example, at least one of hardware resources, such as an I/O resource and a communication resource, and software resources, such as a process resource) on the server 2. On the basis of the load information, the multiplicity determination section 1b calculates an increase in load on each resource caused by increasing the multiplicity of a process which is being performed by the server 2, and determines a multiplicity by which a load on each of all resources becomes smaller than or equal to an upper limit value set in advance. The multiplicity control section 1c changes the multiplicity of the process which is being performed by the server 2 to the multiplicity determined by the multiplicity determination section 1b.

In the above load control apparatus 1, the load information acquisition section 1a acquires load information regarding loads on the CPU resource and the other resources on the server 2. On the basis of the load information, the multiplicity determination section 1b then calculates an increase in load on each resource caused by increasing the multiplicity of the process which is being performed by the server 2, and determines a multiplicity by which a load on each of all the resources becomes smaller than or equal to an upper limit value set in advance. The multiplicity control section 1c changes the multiplicity of the process which is being performed by the server 2 to the multiplicity determined by the multiplicity determination section 1b.

As a result, when the multiplicity is increased, a processing load on each resource on the server does not become excessive and the process can be performed at a multiplicity that is most suitable from the viewpoint of processing efficiency.

In addition to adjusting the multiplicity of the process, an interval may be set for I/O access when a load caused by I/O access, communication, or the like reaches an upper limit value. Setting an interval for I/O access reduces wait time for the I/O access and therefore improves processing efficiency.

As stated above, when the load on the I/O resource exceeds the upper limit value, an interval is adjusted and multiplicity control (the starting, stopping, or the like of a process performed) is not exercised. By adjusting the interval and reducing the load caused by an I/O process, however, the frequency with which a process waiting for I/O processing appears in the server can be decreased and the number of processes which can simultaneously be performed can be increased. As a result, the same effect of improvement in processing efficiency that is obtained by increasing a multiplicity can be realized.

That is to say, when an I/O load is excessive, a long I/O wait occurs. The CPU does not perform a process waiting for I/O. Therefore, even if three processes, for example, are simultaneously performed, a multiplicity may be two from the viewpoint of efficiency in processing by the CPU resource.

If at this time the I/O load is reduced by adjusting an interval, then I/O processing wait time is shortened. As a result, the CPU can simultaneously perform all of the processes started, resulting in efficient processing.

When the load on the I/O resource is smaller than or equal to the upper limit value, an interval is not adjusted. An interval is adjusted in order to prevent I/O wait time from becoming longer. However, when the load on the I/O resource is smaller than or equal to the upper limit value, I/O wait time corresponding to the load is short and does not change appreciably. Accordingly, there is no need to set an interval.

The embodiment of the present invention will now be described in detail. In the following embodiment, it is assumed that an interval is controlled for access to an I/O resource or a communication resource.

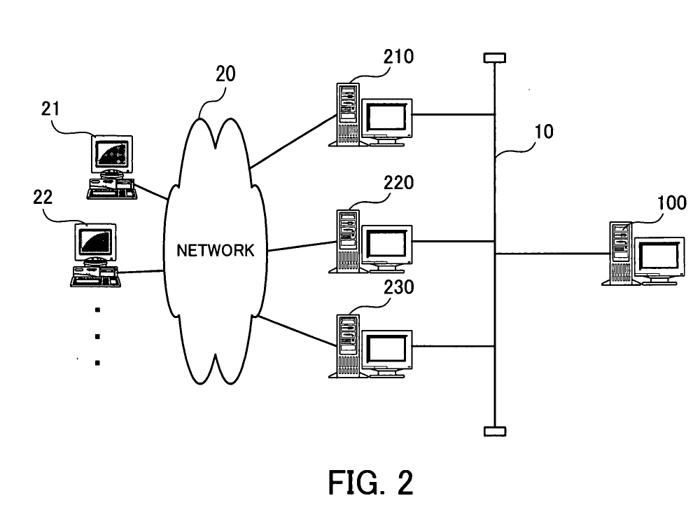

FIG. 2 shows an example of the system configuration of the embodiment of the present invention. A performance management server 100 is connected to application servers 210, 220, and 230 via a local area network (LAN) 10 for management. The application servers 210, 220, and 230 provide various services to clients 21, 22, etc. via a network 20. The application servers 210, 220, and 230 send their resource load information to the performance management server 100. In addition, each of the application servers 210, 220, and 230 changes the multiplicity of service-providing affairs and an I/O interval in response to a request from the performance management server 100.

The performance management server 100 manages the performance of the application servers 210, 220, and 230 and adjusts a balance among loads on the application servers 210, 220, and 230. To be concrete, the performance management server 100 instructs the application server 210, 220, or 230 which has processing capability to spare to increase a multiplicity and set a proper interval.

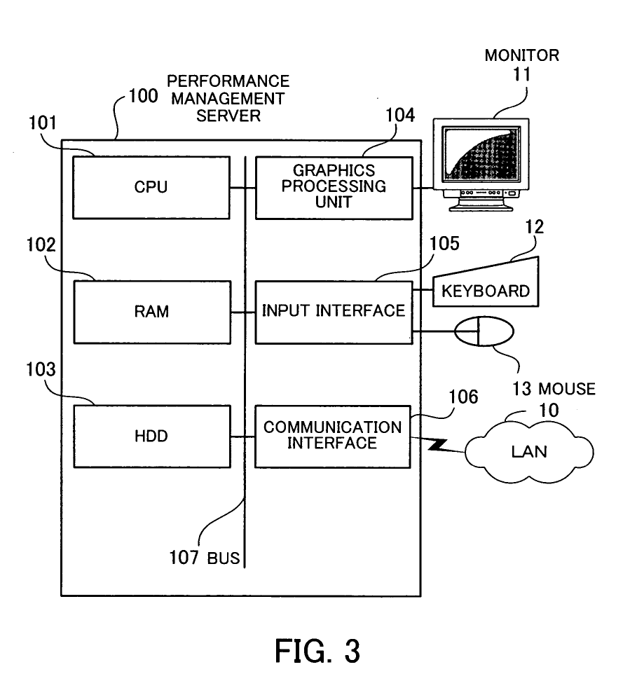

FIG. 3 shows an example of the hardware configuration of the performance management server used in the embodiment of the present invention. The whole of the performance management server 100 is controlled by a CPU 101. A random access memory (RAM) 102, a hard disk drive (HDD) 103, a graphics processing unit 104, an input interface 105, and a communication interface 106 are connected to the CPU 101 via a bus 107.

The RAM 102 temporarily stores at least part of an operating system (OS) or an application program executed by the CPU 101. The RAM 102 also stores various pieces of data which the CPU 101 needs to perform a process. The HDD 103 stores the OS and application programs.

A monitor 11 is connected to the graphics processing unit 104. In accordance with instructions from the CPU 101, the graphics processing unit 104 displays an image on a screen of the monitor 11. A keyboard 12 and a mouse 13 are connected to the input interface 105. The input interface 105 sends a signal sent from the keyboard 12 or the mouse 13 to the CPU 101 via the bus 107.

The communication interface 106 is connected to the LAN 10. The communication interface 106 exchanges data with the application servers 210, 220, and 230 via the LAN 10.

The processing function of the embodiment of the present invention can be realized by adopting the above-mentioned hardware configuration. In FIG. 3, an example of the hardware configuration of the performance management server 100 is shown. The application servers 210, 220, and 230 and the clients 21, 22, etc. can be realized by adopting the same hardware configuration.

The processing functions of the application servers 210, 220, and 230 and the performance management server 100 will now be described.

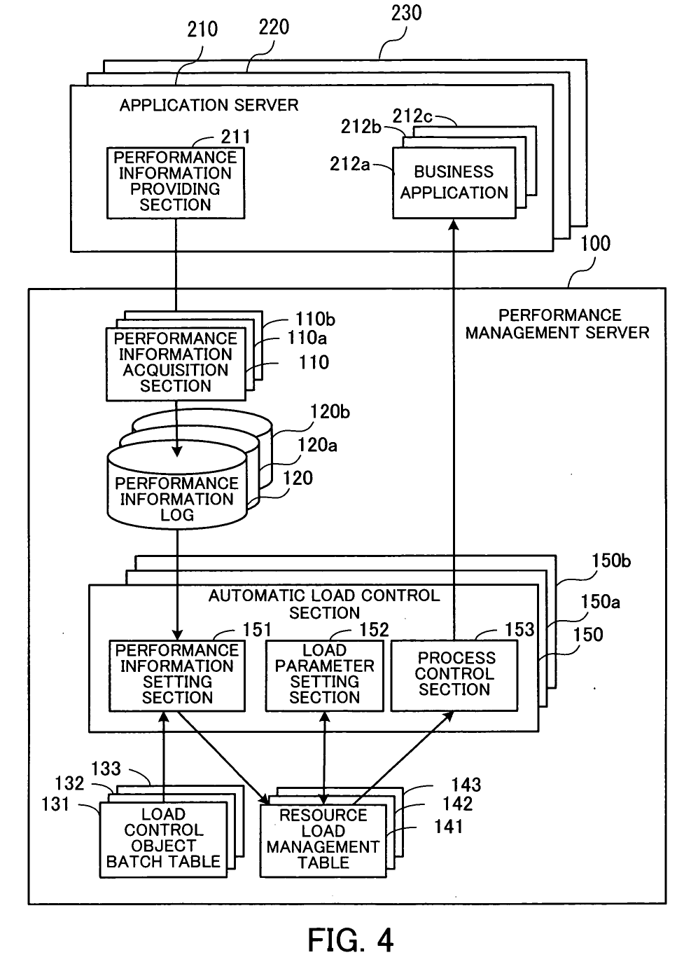

FIG. 4 is a block diagram showing a function for managing performance. The application server 210 includes a performance information providing section 211 and business applications 212a, 212b, and 212c.

The performance information providing section 211 acquires load information regarding a CPU, I/O, a network, and processes for the application server 210 and sends it to the performance management server 100. To be concrete, the performance information providing section 211 acquires pieces of information, such as a business processing group name, resource usage (load factor), resource use time, and process performance time, for each of the business applications 212a, 212b, and 212c and sends them to the performance management server 100 as performance information. Services are provided to the clients 21, 22, etc. by the business applications 212a, 212b, and 212c. Each of the business applications 212a, 212b, and 212c can start a plurality of processes and perform them simultaneously.

FIG. 4 shows the function of the application server 210. The application servers 220 and 230 have the same function. The performance management server 100 includes performance information acquisition sections 110, 110a, and 110b corresponding to the application servers 210, 220, and 230 respectively, performance information logs 120, 120a, and 120b corresponding to the application servers 210, 220, and 230 respectively, load control object batch tables 131, 132, and 133 corresponding to the application servers 210, 220, and 230 respectively, resource load management tables 141, 142, and 143 corresponding to the application servers 210, 220, and 230 respectively, and automatic load control sections 150, 150a, and 150b corresponding to the application servers 210, 220, and 230 respectively.

The performance information acquisition sections 110, 110a, and 110b acquire performance information from the corresponding application servers 210, 220, and 230 and store it in the corresponding performance information logs 120, 120a, and 120b. The performance information logs 120, 120a, and 120b are storage media for storing the performance information acquired from the corresponding application servers 210, 220, and 230.

Processes for which load control is to be exercised and the maximum multiplicity of each of the processes are defined in the load control object batch tables 131, 132, and 133. Load control is exercised only for long batch processes (batch processes which takes predetermined time or more to perform).

The reason for excluding a batch process which is completed in a short period of time from the object of load control is as follows. A load on a system caused by a batch process which is completed in a short period of time is originally small, so there is no need to control a multiplicity. In the present invention an online process is also excluded from the load control. An online process is performed in response to a request from a client. Resources must be assigned to it with some margin left. Therefore, it is not appropriate to determine one multiplicity from the current processing load.

The resource load management tables 141, 142, and 143 are databases for managing a load on each resource (CPU, I/O, communication, or process). The details of the resource load management tables 141, 142, and 143 will be described later.

The automatic load control sections 150, 150a, and 150b calculate optimum multiplicities and intervals for the corresponding application servers 210, 220, and 230 on the basis of the performance information stored in the corresponding performance information logs 120, 120a, and 120b. The automatic load control sections 150, 150a, and 150b then inform the corresponding application servers 210, 220, and 230 of the multiplicities and intervals they calculated. To perform these processes, the automatic load control section 150 includes a performance information setting section 151, a load parameter setting section 152, and a process control section 153.

The performance information setting section 151 refers to the performance information log 120 and the load control object batch table 131 and specifies business applications (long batch processes) for which load control is to be exercised from among business applications currently executed. The performance information setting section 151 then acquires load information regarding the business applications for which load control is to be exercised from the performance information log 120 and sets it in the resource load management table 141.

The load parameter setting section 152 refers to the resource load management table 141 and calculates an optimum multiplicity and interval for each of the business applications. The load parameter setting section 152 then updates the resource load management table 141 by using the calculated optimum multiplicity and interval.

When multiplicities and intervals for the business applications registered in the resource load management table 141 are updated, the process control section 153 sends the new contents to an application server which executes the business applications.

The other automatic load control sections 150a and 150b (not shown) have the same function as that of the automatic load control section 150.

The contents of various pieces of data stored in the performance management server 100 will now be described in detail.

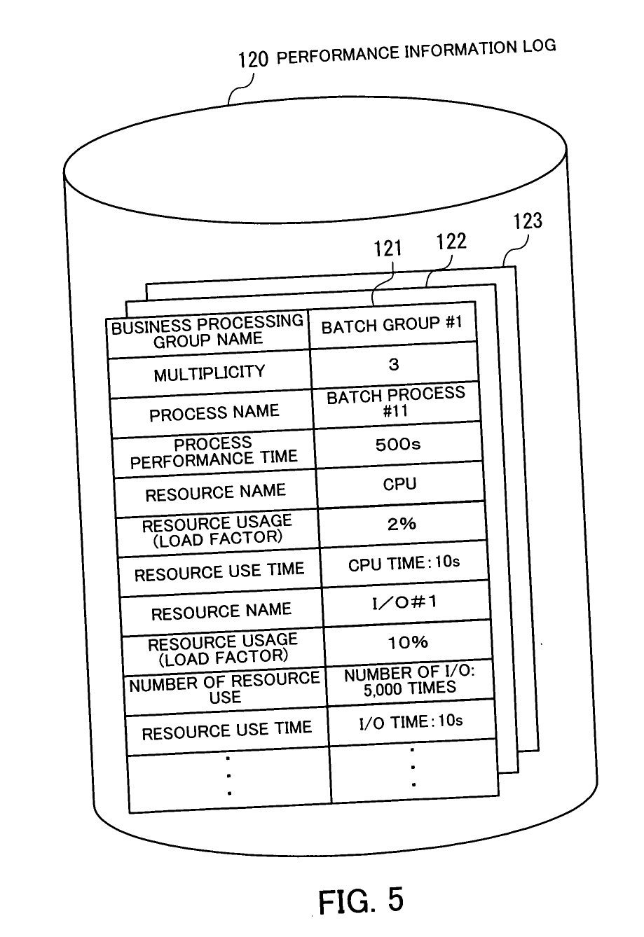

FIG. 5 shows an example of the data structure of the performance information log. In this example, pieces of performance information 121, 122, 123, etc. according to affairs using each resource are registered in the performance information log 120. A business processing group name, a multiplicity, a process name, process performance time, a resource name, resource usage (load factor), resource use time, the number of resource use, and the like are included in each of the pieces of performance information 121, 122, 123, etc.

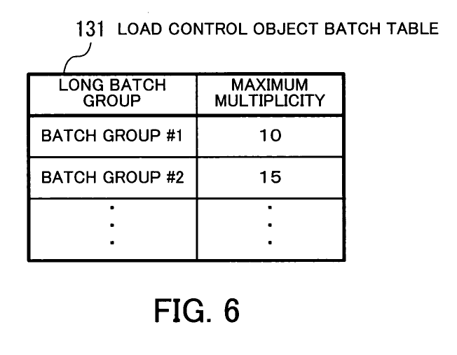

FIG. 6 shows an example of the data structure of the load control object batch table. In the load control object batch table 131, the group numbers of batch processes (long batch process) which take predetermined time or more to perform on the application server 210 are registered and the maximum multiplicity of each long batch process is set. When the maximum multiplicity of each long batch process performed on each application server is set, imbalance in multiplicity among the application servers which perform business processing is taken into consideration and a maximum multiplicity in the entire system is distributed. Long batch processes are registered in the load control object batch table 131 in descending order of priority.

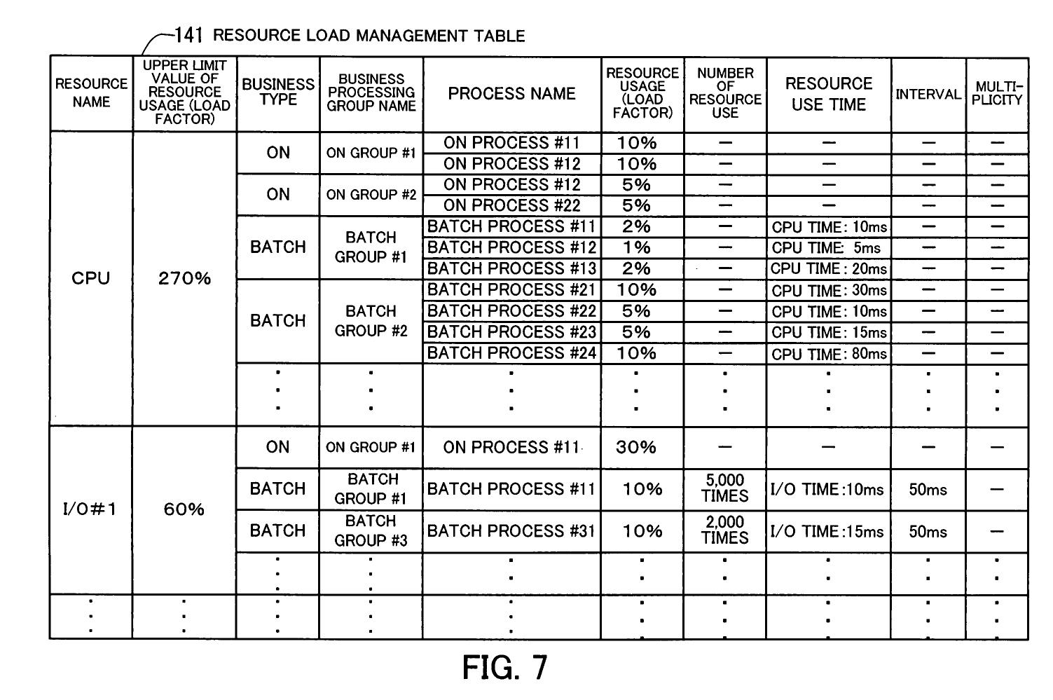

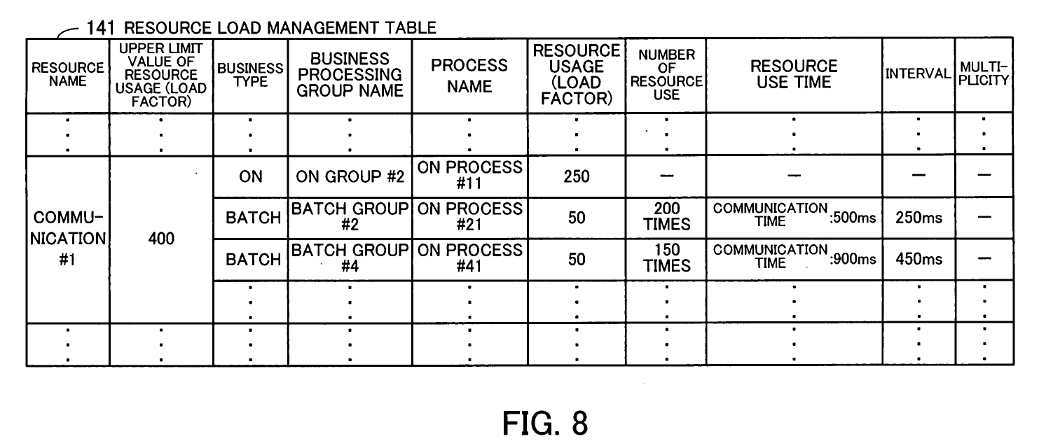

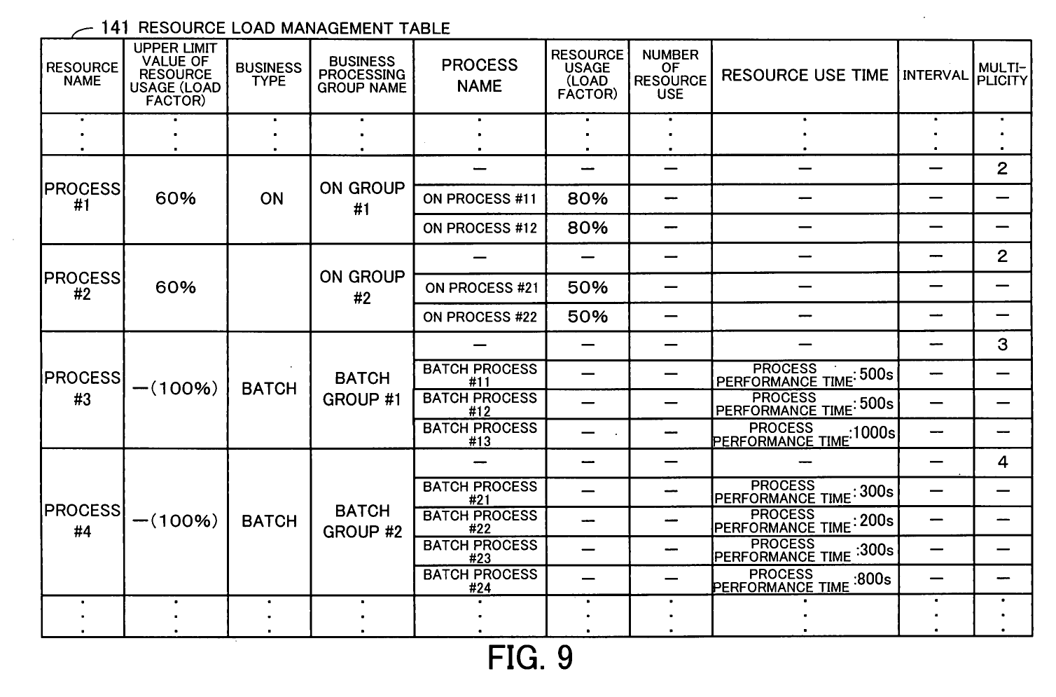

The data structure of the resource load management tables will now be described with reference to FIGS. 7 through 9. FIG. 7 shows information regarding a CPU resource and an I/O resource included in the resource load management table. FIG. 8 shows information regarding a communication resource included in the resource load management table. FIG. 9 shows information regarding a process resource included in the resource load management table.

Resource Name, Upper Limit Value of Resource Usage (Load Factor), Business Type, Business Processing Group Name, Process Name, Resource Usage (Load Factor), Number of Resource Use, Resource Use Time, Interval, and Multiplicity columns are included in the resource load management table 141.

The name of a resource in the application server to be managed is set in the Resource Name column. To be concrete, “CPU,” “I/O,” “communication,” or “process” is registered in the Resource Name column. A CPU resource is managed as one resource in one application server. For example, even if the application server includes multiple CPUs, they are managed as one CPU resource in the resource load management table 141.

All I/O devices (such as a storage device) that can be accessed from the application server are registered in the Resource Name column as I/O resources. Identification numbers are given to the I/O resources registered in the Resource Name column to identify them in the application server.

All communication lines that are connected to the application server are registered in the Resource Name column as communication resources. Identification numbers are given to the communication resources registered in the Resource Name column to identify them in the application server.

All processes that are assigned to online processing or batch processing are registered in the Resource Name column as process resources. Identification numbers are given to the process resources registered in the Resource Name column to identify them in the application server.

The upper limit value of the usage or load factor of each resource in an online process or a long batch process managed by the load control object batch table 131 is set in the Upper Limit Value of Resource Usage (Load Factor) column. The load factor of each resource in a process other than an online process and a long batch process is calculated on the basis of an actual value in an existing system or an estimate. The upper limit value of the load factor of each of the CPU resource and the I/O resources is indicated by the ratio (percentage) of resource usage to maximum processing capability. The upper limit value of the load factor of each of the communication resources is indicated by the number of output buffers used. With online process (in which online processing is performed) resources, the upper limit value of a process load assigned to online processing is set. 100 percent of each batch process resource may be used, so the upper limit value of a load factor is not set. When the upper limit value of the usage (load factor) of an I/O resource or a communication resource shared among the applications is set, imbalance in load on the application server 210 which performs business processing is taken into consideration and the resource on the application server 210 is distributed.

In the example shown in FIG. 7, 270% is set as the upper limit value of the load factor of the CPU resource. In this case, the application server includes three CPUs. The maximum processing capability of one CPU is 100%.

In the example shown in FIG. 9, the upper limit value of the resource usage (load factor) of each batch process is indicated by “-” (blank). This means that an upper limit value is not set, that is to say, 100 percent of each batch process resource can be used.

The business type of a business processing group registered in the Business Processing Group Name column is set in the Business Type column. In FIGS. 7 through 9, online processing is indicated by “ON” and batch processing is indicated by “BATCH”.

The name of a business processing group which conducts each piece of business is set in the Business Processing Group Name column. With batch groups, long batch groups managed by the load control object batch table 131 are set in the Business Processing Group Name column. The name “ON GROUP #1” (1 is an integer greater than or equal to one) is given to a business processing group which performs online processing. The name “BATCH GROUP #k” (k is an integer greater than or equal to one) is given to a business processing group which performs batch processing.

The name of a process in which each piece of business is conducted is set in the Process Name column. The name “ON PROCESS #m” (m is an integer greater than or equal to one) is given to a process in which online processing is performed. The name “BATCH PROCESS #n” (n is an integer greater than or equal to one) is given to a process in which batch processing is performed.

The usage or load factor of each resource used in each process is set in the Resource Usage (Load Factor) column. The Resource Usage (Load Factor) column corresponding to a process in which a resource is not used is blank.

The number of times an I/O resource or a communication resource is used in each process is set in the Number of Resource Use column.

CPU time or process performance time after the time when load information was acquired the last time in each batch process is set in the Resource Use Time column. In addition, time for which an I/O resource or a communication resource is used per unit processing in each batch process is set in the Resource Use Time column.

An interval set for each batch group when an I/O resource or a communication resource is used is set in the Interval column.

A multiplicity in the current business processing group is set in the Multiplicity column.

Data is set in advance in the Resource Name, Upper Limit Value of Resource Usage (Load Factor), Business Type, Business Processing Group Name, and Process Name columns by a system manager. An initial value is set in the Multiplicity column by the system manager. When the performance management server 100 begins automatic load control, the performance information setting section 151 properly sets data in the Resource Usage (Load Factor), Number of Resource Use, and Resource Use Time columns. In addition, the load parameter setting section 152 sets data in the Interval and Multiplicity columns.

Automatic load control is exercised by adopting the above system configuration. The procedure for automatic load control exercised by the automatic load control section 150 corresponding to the application server 210 will now be described in detail.

First, in the performance management server 100 the performance information acquisition section 110 acquires performance information from the application server 210 and stores it in the performance information log 120. The performance information setting section 151 refers to the load control object batch table 131 and sets performance information regarding a batch group (long batch group) for which load control is to be exercised in the resource load management table 141.

The load parameter setting section 152 is started at predetermined time intervals. The load parameter setting section 152 started calculates proper load parameters (multiplicity and interval) on the basis of the performance information set in the resource load management table 141 and sets these parameters in the resource load management table 141.

Time intervals at which the load parameter setting section 152 is started is determined on the basis of, for example, average batch processing time. That is to say, if the average batch processing time is three minutes, then the load parameter setting section 152 is started at intervals of three minutes.

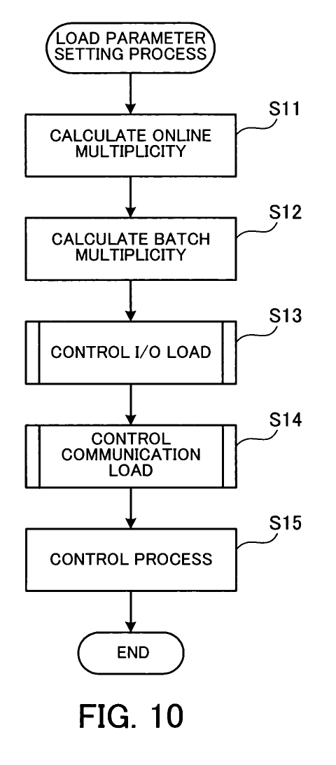

FIG. 10 is a flow chart showing the procedure for a load parameter setting process. The process shown in FIG. 10 will now be described in order of step number.

[Step S11] The load parameter setting section 152 calculates an online multiplicity in each online group. An online multiplicity is calculated by
online multiplicity=(load factor of online process+upper limit value of load of online process)/upper limit value of load of online process (1)

where load factor of online process is the sum of the load factors of processes simultaneously performed in a target online group (values in the Resource Usage (Load Factor) column of online processes corresponding to a process resource in the resource load management table 141) and upper limit value of load of online process is a value in the Upper Limit Value of Resource Usage (Load Factor) column of the online group corresponding to the process resource in the resource load management table 141 (the upper limit value of resource usage (load factor) in one process in the online group).

[Step S12] The load parameter setting section 152 calculates a multiplicity in a batch group (batch multiplicity).

[Step S13] The load parameter setting section 152 repeatedly performs an I/O load control process on all I/O resources the upper limit values of the load factors of which are exceeded. The details of the I/O load control process will be described later.

[Step S14] The load parameter setting section 152 repeatedly performs a communication load control process on all communication resources the upper limit values of the load factors of which are exceeded. The details of the communication load control process will be described later.

[Step S15] The process control section 153 controls the starting or stopping of a process performed by the application server 210 and an interval on the basis of load parameters (multiplicity and interval) set in the resource load management table 141.

To be concrete, the process control section 153 refers to the resource load management table 141. If the multiplicity of a business processing group increases compared with what it was before the load parameter setting process, then the process control section 153 sends a request to start a process for handling the business processing group to the application server which performs the business processing group. If the multiplicity of a business processing group decreases compared with what it was before the load parameter setting process, then the process control section 153 sends a request to stop a process for handling the business processing group to the application server which performs the business processing group.

If the multiplicity of a batch group is decreased, the application server suspends a batch process. In this case, the application server does not stop the batch process completely. The application server resumes performing the batch process suspended when a batch process which is being performed is completed or when a request to start a process is made because of an increase in multiplicity.

If the multiplicity of an online group is decreased, the application server stops an online process at the time when the online process gets unused.

The batch multiplicity calculation process will now be described. To calculate a batch multiplicity, a load simulation table which indicates the relationship between a multiplicity and resource usage (load factor) for each processing group is generated in the load parameter setting section 152.

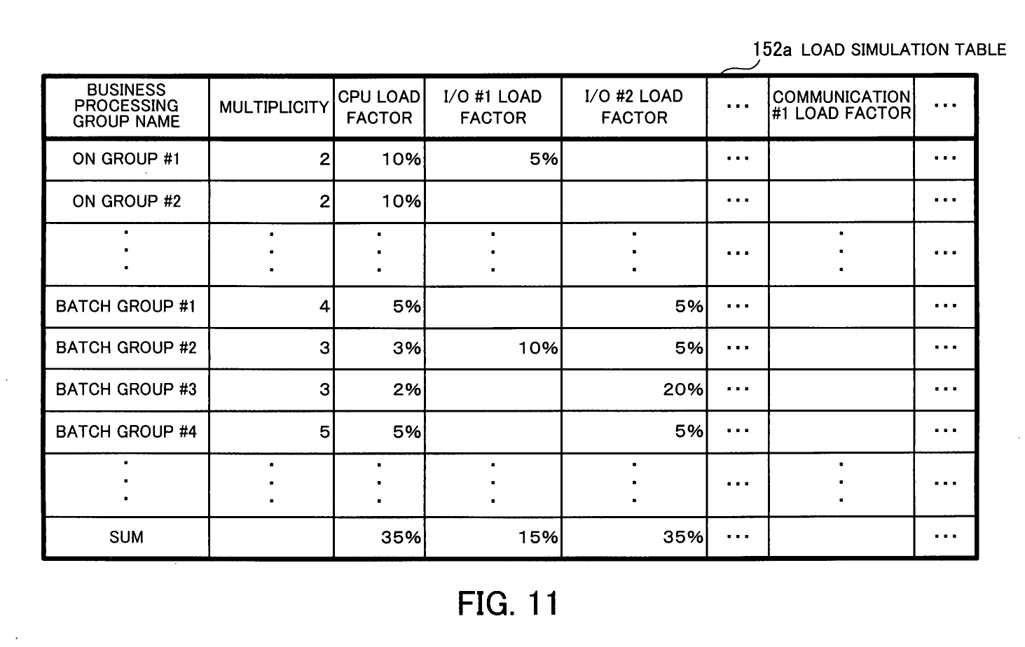

FIG. 11 shows an example of the data structure of a load simulation table. A load simulation table 152a includes Business Processing Group Name, Multiplicity, CPU Load Factor, I/O #1 Load Factor, I/O #2 Load Factor, . . . , Communication #1 Load Factor, . . . columns for each business processing group.

The name of processing group which is being performed by the application server is set in the Business Processing Group Name column. With batch groups, long batch groups managed by the load control object batch table 131 are set in the Business Processing Group Name column in descending order of priority.

With online groups, a current multiplicity of each processing group is set in the Multiplicity column as an initial value. With batch groups, zero is set in the Multiplicity column as an initial value. A current CPU load factor per batch process in each processing group is set in the CPU Load Factor column as an initial value. A current I/O load factor per batch process in each processing group is set in each of the I/O #1 Load Factor, I/O #2 Load Factor, . . . columns as an initial value. A current communication load factor per batch process in each processing group is set in each of the Communication #1 Load Factor, . . . columns as an initial value.

The load parameter setting section 152 selects the batch groups registered in the load simulation table 152a in order of mention (priority). The load parameter setting section 152 increments the multiplicity of a batch group selected by one. After incrementing the multiplicity of the batch group, the load parameter setting section 152 calculates a CPU load factor and I/O load factors and sets them in the corresponding CPU Load Factor, I/O #1 Load Factor, I/O #2 Load Factor, . . . columns corresponding to the batch group selected.

For example, after incrementing the multiplicity of the batch group selected, the load parameter setting section 152 multiplies the CPU load factor per batch process by the incremented multiplicity to calculate the CPU load factor. The I/O load factors can be calculated in the same way.

After calculating the load factor of each resource, the load parameter setting section 152 determines whether the upper limit value of the usage (load factor) of each resource is exceeded. If the upper limit value of the usage (load factor) of each resource is not exceeded, then the load parameter setting section 152 settles the incremented multiplicity of the batch group selected. If the upper limit value of the usage (load factor) of at least one resource is exceeded, then the load parameter setting section 152 does not increment the multiplicity of the batch group selected. In this case, incrementing the multiplicity of the batch group selected is canceled.

If the load parameter setting section 152 settles the incremented multiplicity of the batch group selected, then the load parameter setting section 152 refers to the load control object batch table 131 and determines whether the incremented multiplicity has reached the maximum multiplicity of the batch group. If the incremented multiplicity has reached the maximum multiplicity of the batch group, then the load parameter setting section 152 does not increment the multiplicity of the batch group selected any more.

The above process is performed on the batch groups the load parameter setting section 152 selects in order. When examination of whether to increment the multiplicity of a batch group registered last in the load simulation table 152a is completed, again the load parameter setting section 152 selects the batch groups which are registered in the load simulation table 152a and the multiplicities of which can be incremented in order of mention and examines whether to increment their multiplicities.

If the load parameter setting section 152 does not increment the multiplicities of all of the batch groups registered in the load simulation table 152a any more, then the load parameter setting section 152 terminates the multiplicity calculation process. Multiplicities registered in the Multiplicity column in the load simulation table 152a at the time when the load parameter setting section 152 terminates the multiplicity calculation process are the multiplicities of the corresponding batch groups.

The I/O load control process will now be described in detail. In the following description, it is assumed that an I/O load on the application server corresponding to the resource load management table 141 is controlled.

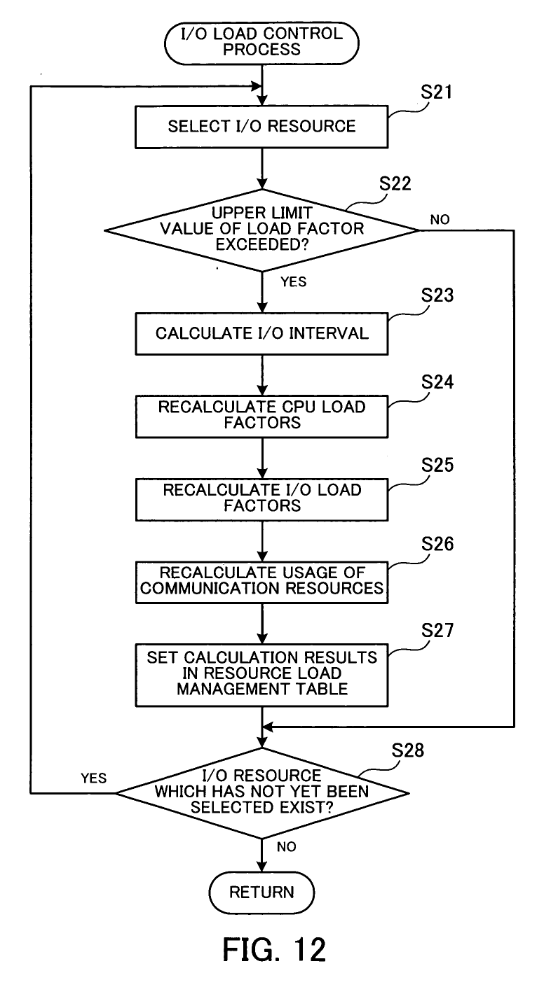

FIG. 12 is a flow chart showing the procedure for the I/O load control process. The process shown in FIG. 12 will now be described in order of step number.

[Step S21] The load parameter setting section 152 selects one I/O resource from the resource load management table 141.

[Step S22] The load parameter setting section 152 refers to the resource load management table 141 and determines whether the sum of the resource usage (load factors) of all business processing groups in which the selected I/O resource is used is greater than the upper limit value of resource usage (load factor). If the sum of the resource usage (load factors) of all business processing groups in which the selected I/O resource is used is greater than the upper limit value of resource usage (load factor), then step S23 is performed. If the sum of the resource usage (load factors) of all business processing groups in which the selected I/O resource is used is not greater than the upper limit value of resource usage (load factor), then step S28 is performed.

[Step S23] The load parameter setting section 152 calculates an I/O interval for each of batch processes in which the selected I/O resource is used. To be concrete, an I/O interval is calculated by
I/O interval=(I/O processing time÷((upper limit value of I/O load−online group I/O load factor)÷sum of batch multiplicities))−I/O processing time (2)

where I/O processing time is I/O resource use time corresponding to a batch process in which the I/O resource selected from the resource load management table 141 in step S21 is used and therefore I/O processing time values differ among different batch processes, upper limit value of I/O load is the upper limit value of resource usage (load factor) corresponding to the I/O resource selected from the resource load management table 141, online group I/O load factor is the sum of the load factors (values in the Resource Usage (Load Factor) column) of all online processes corresponding to the I/O resource selected from the resource load management table 141, and sum of batch multiplicities is the total number of batch processes (for which the Resource Usage (Load Factor) column is not blank) in which the I/O resource selected is being used of batch processes corresponding to the I/O resource selected from the resource load management table 141.

The term “(upper limit value of I/O load−online group I/O load factor)” in equation (2) indicates I/O processing capability (processing capability which can be assigned to batch processing) obtained by subtracting the load factors of online groups from the upper limit value of an I/O load. By dividing the processing capability which can be assigned to batch processing by “sum of batch multiplicities,” processing capability (numeric value indicative of ratio obtained if 100 percent of the I/O processing capability is considered to be one) which can be assigned to one batch process is found out.

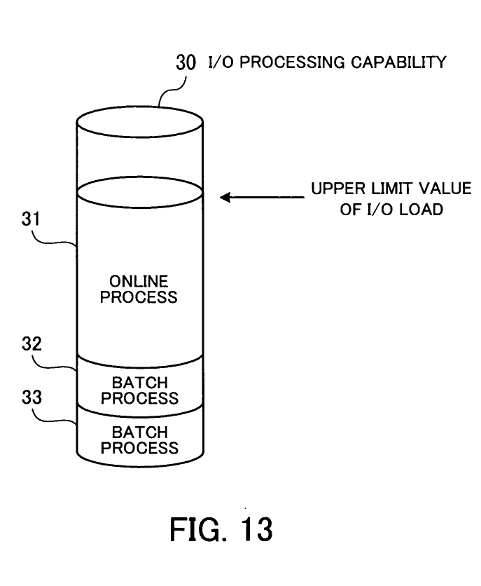

FIG. 13 is a schematic view showing processing capability which can be assigned to one batch process. In FIG. 13, a processing load smaller than or equal to the upper limit value of an I/O load of I/O processing capability 30 can be applied. Processing capability 31 for online processes is subtracted from the processing capability corresponding to the upper limit value of an I/O load and processing capabilities 32 and 33 which can be assigned to batch processes remain. In this embodiment, processing capability is equally assigned to batch processes even if they belong to different batch groups.

On the basis of the processing capability which can be assigned to one batch process and which is obtained in this way, an I/O interval for a batch process in each batch group is calculated. That is to say, processing time per I/O processing in a batch process is “I/O processing time+I/O interval”. An I/O interval is determined so that the ratio of the I/O processing time to the processing time per I/O processing in a batch process will correspond to the processing capability which can be assigned to one batch process. This can be expressed as
I/O processing time÷(I/O processing time+I/O interval)=processing capability which can be assigned to one batch process (3)

By solving equation (3) about I/O interval, equation (2) is obtained.

To return, the rest of the process shown in FIG. 12 will now be described.

[Step S24] The load parameter setting section 152 recalculates CPU load factors in the batch processes in which the selected I/O resource is used. To be concrete, the load parameter setting section 152 calculates the ratio of process performance time to CPU time for each of the batch processes corresponding to the I/O resource selected from the resource load management table 141 to obtain the load factor of the CPU resource. The process performance time is recalculated on the basis of the interval determined in step S23 and the number of times the resource is used.

[Step S25] The load parameter setting section 152 recalculates I/O load factors in the batch processes in which the selected I/O resource is used. To be concrete, the load parameter setting section 152 calculates the ratio of process performance time to I/O time for each of the batch processes corresponding to the I/O resource selected from the resource load management table 141 to obtain the load factor of the I/O resource. The process performance time is recalculated on the basis of the interval determined in step S23 and the number of times the resource is used.

[Step S26] The load parameter setting section 152 recalculates the usage of communication resources in the batch processes in which the selected I/O resource is used. To be concrete, the load parameter setting section 152 calculates the ratio of process performance time to communication time for each of the batch processes corresponding to the I/O resource selected from the resource load management table 141 and considers the number of communication buffers corresponding to this ratio as the usage of the communication resources. The process performance time is recalculated on the basis of the interval determined in step S23 and the number of times the resource is used.

[Step S27] The load parameter setting section 152 sets the usage (load factor) of each resource calculated in step S24 through S26 in the Resource Usage (Load Factor) column in the resource load management table 141.

[Step S28] The load parameter setting section 152 determines whether an I/O resource which has not yet been selected exists. If an I/O resource which has not yet been selected exists, then step S21 is performed. If all I/O resources have been selected and the I/O load control process is completed, then the process terminates.

The communication load control process will now be described in detail. In the following description, it is assumed that a communication load on the application server corresponding to the resource load management table 141 is controlled.

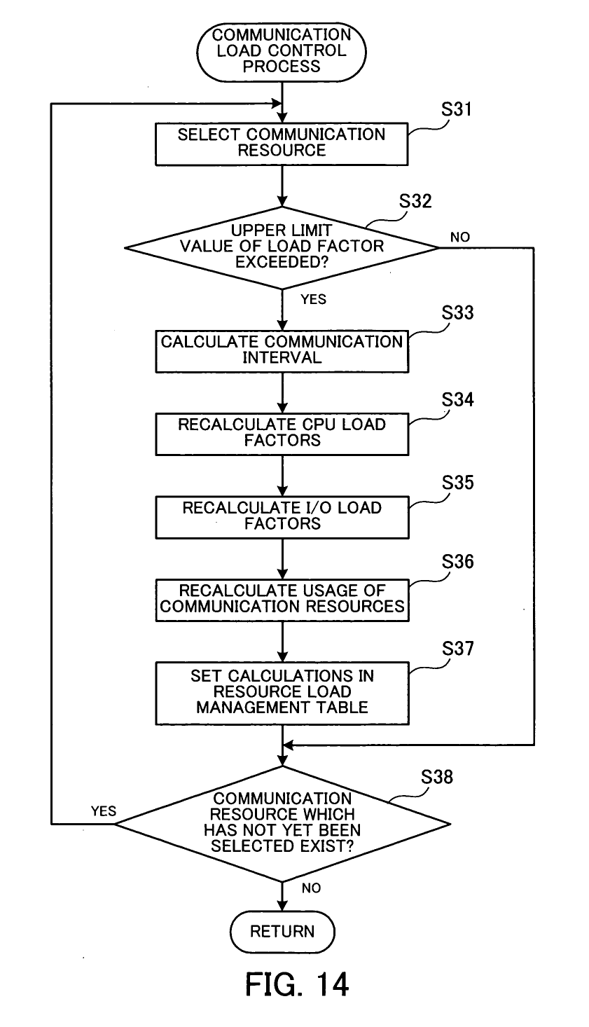

FIG. 14 is a flow chart showing the procedure for the communication load control process. The process shown in FIG. 14 will now be described in order of step number.

[Step S31] The load parameter setting section 152 selects one communication resource from the resource load management table 141.

[Step S32] The load parameter setting section 152 refers to the resource load management table 141 and determines whether the sum of the resource usage (load factors) of all business processing groups in which the selected communication resource is used is greater than the upper limit value of resource usage (load factor). If the sum of the resource usage (load factors) of all business processing groups in which the selected communication resource is used is greater than the upper limit value of resource usage (load factor), then step S33 is performed. If the sum of the resource usage (load factors) of all business processing groups in which the selected communication resource is used is not greater than the upper limit value of resource usage (load factor), then step S38 is performed.

[Step S33] The load parameter setting section 152 calculates a communication interval for each of batch processes in which the selected communication resource is used. To be concrete, a communication interval is calculated by
communication interval=(communication processing time ÷((upper limit value of communication load−number of buffers used in online groups)÷sum of batch multiplicities))−communication processing time (4)

where communication processing time is communication resource use time corresponding to a batch process in which the communication resource selected from the resource load management table 141 in step S31 is used and therefore communication processing time values differ among different batch processes, upper limit value of communication load is the upper limit value of resource usage (load factor) corresponding to the communication resource selected from the resource load management table 141, number of buffers used in online group is the sum of the load factors (values in the Resource Usage (Load Factor) column) of all online processes corresponding to the communication resource selected from the resource load management table 141, and sum of batch multiplicities is the total number of batch processes (for which the Resource Usage (Load Factor) column is not blank) in which the communication resource selected is being used of batch processes corresponding to the communication resource selected from the resource load management table 141.

The term “(upper limit value of communication load−number of buffers used in online groups)” in equation (4) indicates the storage capacity of communication buffers for communication (the number of buffers which can be assigned to batch processing) obtained by subtracting the number of buffers used in online groups from the upper limit value of a communication load. By dividing the processing capability which can be assigned to batch processing by “sum of batch multiplicities,” the ratio of the storage capacity of communication buffers (numeric value indicative of ratio obtained if the total storage capacity of all communication buffers is considered to be one) which can be assigned to one batch process is found out.

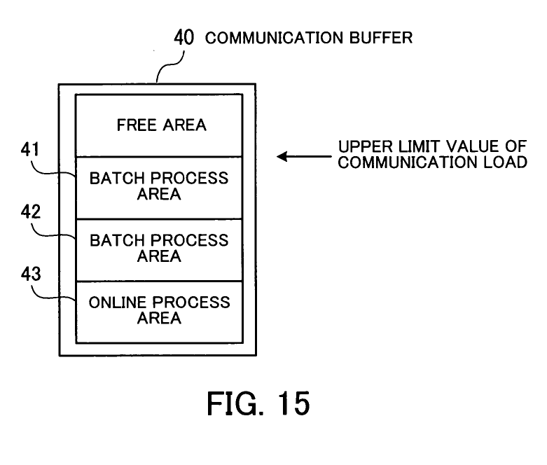

FIG. 15 is a schematic view showing the storage capacity of a communication buffer which can be assigned to one batch process. In FIG. 15, a portion of the entire storage capacity of a communication buffer 40 corresponding to the upper limit value of a communication load can be used in processes. An online process area 43 is subtracted from the storage capacity corresponding to the upper limit value of a communication load and batch process areas 41 and 42 remain. In this embodiment, the communication buffer is equally assigned to batch processes even if they belong to different batch groups.

On the basis of the storage capacity of the communication buffer which can be assigned to one batch process and which is obtained in this way, a communication interval for a batch process in each batch group is calculated. That is to say, processing time per communication processing in a batch process is “communication processing time+communication interval”. A communication interval is determined so that the ratio of the communication processing time to the processing time per communication processing in a batch process will correspond to the ratio of storage capacity of the communication buffer which can be assigned to one batch process. This can be expressed as
communication processing time÷(communication processing time+communication interval)=ratio of storage capacity of communication buffer which can be assigned to one batch process (5)

By solving equation (5) about communication interval, equation (4) is obtained.

To return, the rest of the process shown in FIG. 14 will now be described.

[Step S34] The load parameter setting section 152 recalculates CPU load factors in the batch processes in which the selected communication resource is used. To be concrete, the load parameter setting section 152 calculates the ratio of process performance time to CPU time for each of the batch processes corresponding to the communication resource selected from the resource load management table 141 to obtain the load factor of the CPU resource. The process performance time is recalculated on the basis of the interval determined in step S33 and the number of times the resource is used.

[Step S35] The load parameter setting section 152 recalculates I/O load factors in the batch processes in which the selected communication resource is used. To be concrete, the load parameter setting section 152 calculates the ratio of process performance time to I/O time for each of the batch processes corresponding to the communication resource selected from the resource load management table 141 to obtain the load factor of the I/O resource. The process performance time is recalculated on the basis of the interval determined in step S33 and the number of times the resource is used.

[Step S36] The load parameter setting section 152 recalculates the usage of communication resources in the batch processes in which the selected communication resource is used. To be concrete, the load parameter setting section 152 calculates the ratio of process performance time to communication time for each of the batch processes corresponding to the communication resource selected from the resource load management table 141 and considers the number of communication buffers corresponding to this ratio as the usage of the communication resources. The process performance time is recalculated on the basis of the interval determined in step S33 and the number of times the resource is used.

[Step S37] The load parameter setting section 152 sets the load factor of each resource calculated in step S34 through S36 in the Resource Usage (Load Factor) column in the resource load management table 141.

[Step S38] The load parameter setting section 152 determines whether a communication resource which has not yet been selected exists. If a communication resource which has not yet been selected exists, then step S31 is performed. If all communication resources have been selected and the communication load control process is completed, then the process terminates.

An optimum multiplicity and interval are calculated in the above-mentioned way every certain period of time and the multiplicity of batch processing and an interval per resource use (I/O access or communication) in each batch process are changed. The multiplicity of batch processing is changed properly. Accordingly, when, for example, a load by online processing decreases, processing capability assigned to the batch processing increases. As a result, the multiplicity of the batch processing can be increased.

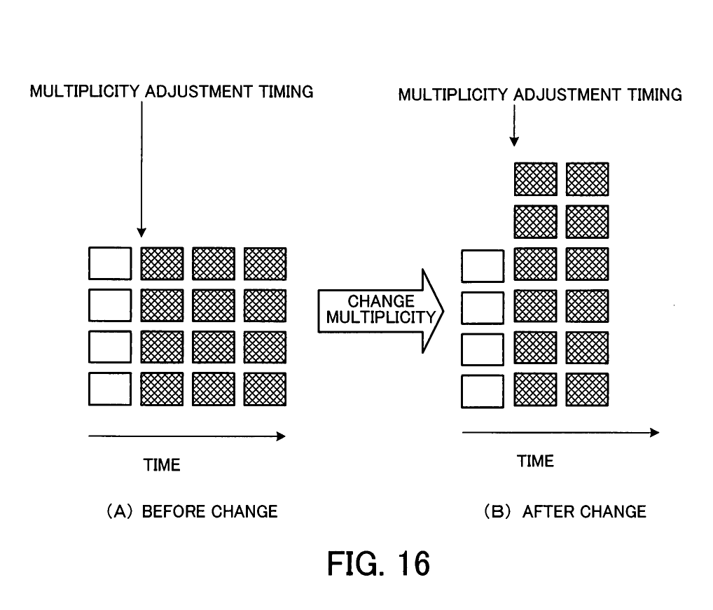

FIG. 16 is a schematic view showing a multiplicity adjustment process. (A) in FIG. 16 shows a schedule of batch processing before a change in multiplicity. (B) in FIG. 16 shows a schedule of the batch processing after the change in multiplicity. In each schedule, a horizontal axis indicates time and each rectangle indicates a process performed.

In this example, the multiplicity of the batch processing is four before the change in multiplicity. The number of batch processes which are not yet performed is twelve. Therefore, if the batch processing is continued without the multiplicity being changed, it takes three batch processing periods to complete all of the batch processes which are not yet performed. If the multiplicity of the batch processing is changed at multiplicity adjustment timing to six, it takes two batch processing periods to complete all of the batch processes which are not yet performed.

If the multiplicity of the batch processing is increased too much, then the processing load on a CPU, I/O, or communication resource becomes excessive. If the processing load on the CPU resource is excessive, the multiplicity is decreased. In many cases, however, the processing load on an I/O or communication resource becomes excessive before the processing load on the CPU resource becomes excessive. In this case, by adjusting an interval, the processing load on the I/O or communication resource can be reduced. Therefore, the processing load does not exceed the maximum load factor and there is no need to decrease the multiplicity.

The reason why adjusting an interval leads to a reduction of the load on a resource can be explained by a queuing theory. The effect of reducing processing time will now be described with the case where an I/O interval is adjusted as an example.

If an operation process by the CPU and I/O access are performed, service time (time which elapsed after a request to perform a process is made and before the process is completed) is
one processing period=real time+wait time (6)

where real time includes time for which the CPU performs a batch process and time for which I/O access is performed in response to an I/O request made in the batch process, and wait time is time which elapsed after requests to perform a process are made to the CPU resource and I/O resources and before the process is performed.

If an M/M/1 model (in which requests reach randomly, service time follows an exponential distribution, and the number of service windows is one), which is based on a queuing theory, is adopted, wait time is given by
wait time=(ρ/(1−ρ))×real time (7)

where ρ is referred to as traffic density and indicates how many processes are piled up. ρ (traffic density) is given by
ρ=λ/μ

where λ is an average request arrival rate (the average number of request arrivals per unit time) and μ is an average request handling rate (the average number of handled requests per unit time).

(ρ/(1−ρ)) indicates the average number of requests to perform a process which stay in a system. That is to say, time taken to handle all requests that stay in a system at the time when a new request to perform a process is made is wait time.

According to equation (7), the greater the value of ρ becomes, the longer wait time becomes. As the value of ρ approaches one, wait time increases sharply. Therefore, by adjusting the value of ρ so as not to exceed a predetermined upper limit value, wait time becomes shorter than or equal to predetermined time.

To decrease the value of ρ, λ should be decreased or μ should be increased. However, μ is determined by the processing capability of hardware. Accordingly, λ should be decreased.

λis an average request arrival rate. In the case of I/O access, λ corresponds to the frequency with which an I/O request is made in a batch process. Accordingly, a request for I/O access should be outputted from the batch process an interval after processing by the CPU. By doing so, the value of λ can be decreased. If the value of λ becomes smaller, then the value of ρ becomes smaller and wait time reduces.

Concrete examples in which processing time is reduced will now be described.

First, it is assumed that batch processing is performed at a multiplicity of 10, that, in the batch processing, CPU processing time is three seconds and I/O time is 30 milliseconds per I/O access, and that in the batch processing I/O access occurs 3,000 times.

One file on a magnetic disk is accessed in the batch process. This file is also accessed from another batch process performed by the CPU. For the sake of calculative simplicity, it is assumed that online processing is not performed. If an interval is not set, the load factor of an I/O resource is 75%. Moreover, it is assumed that many I/O bound processes (in which data is sent to I/O devices) are performed and that a CPU wait does not occur.

[Processing Time Taken If an Interval is not Set]

Entire processing time before the setting of an interval will now be calculated first.

One processing period (time taken to perform one batch process) is given by

$$one processing period = CPU time + I / O time = CPU processing time + I / O processing time = 3 ( seconds ) + 30 ( milliseconds ) ⨯ 3000 ( times ) = 93 ( seconds ) \qquad ( 8 )$$

where CPU time includes wait time (“0,” in this example) and is time the CPU takes to perform one batch process, CPU processing time is time for which the CPU resource is used in one batch process, and I/O processing time is time for which an I/O resource is used in one batch process.

The entire processing time is approximately equal to total I/O time. The total I/O time is (I/O processing time+I/O wait time). Processing time per I/O access is 30 milliseconds and wait time is 90 milliseconds (=(0.75/(1−0.75))×30 milliseconds). Accordingly, 120 milliseconds elapse after a request for I/O access is made and before the processing is completed.

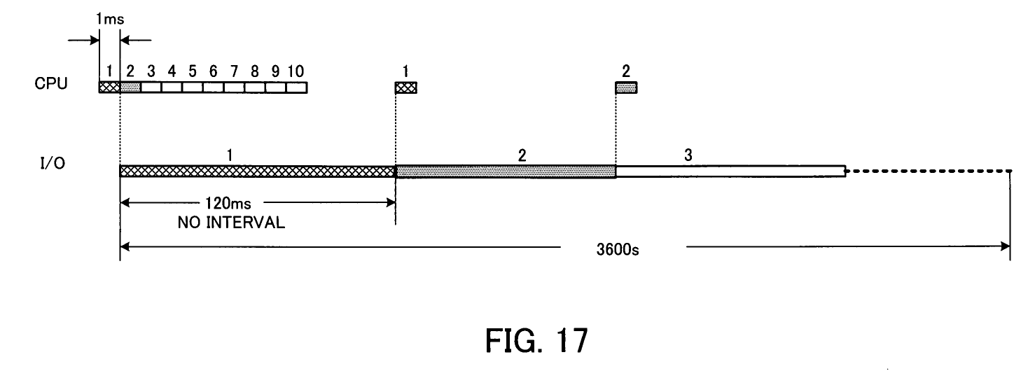

FIG. 17 shows entire processing time taken if no interval is set. In FIG. 17, the relationship between batch processes performed by the CPU and time and the relationship between a batch process in which I/O access is performed and time are shown. The ten batch processes simultaneously performed are numbered from 1 to 10 and a time zone where each batch process is performed is indicated by its number.

120 milliseconds elapse after a request for I/O access is made and before the processing is completed. The batch processing in which I/O access occurs 3,000 times is performed at a multiplicity of 10. Accordingly, the total I/O time is 3,600 seconds (=120 (milliseconds)×3000 (times)×10 (multiplicity)).

This can be written as

$$entire processing time = total I / O time = I / O processing time + I / O wait time = 30 ( milliseconds ) ⨯ ( 1 + ( 0.75 \div ( 1 - 0.75 ) ) ) ⨯ 3000 ( times ) ⨯ 10 ( multiplicity ) = 3600 seconds \qquad ( 9 )$$

[Processing Time Taken if an Interval is Set]

Processing time taken if an interval is set will now be described. An interval is calculated by
I/O processing time÷(I/O processing time+interval)=processing capability which can be assigned to one batch process (10)

For example, if the upper limit value of an I/O load is 60%, then processing capability which can be assigned to one batch process is 6%. By substituting this value for the right-hand side of equation (10), the following equation is obtained.
30 (milliseconds)÷(30(milliseconds)+interval)=0.06

Therefore, interval=470 (milliseconds).

In this case, one processing period is given by one processing period

$$one processing period = CPU time + I / O time = CPU processing time + I / O processing time + interval = 3 ( seconds ) + ( 30 ( milliseconds ) + 470 ( milliseconds ) ) ⨯ 3000 ( times ) = 1503 ( seconds ) \qquad ( 11 )$$

Compared with the one processing period (93 seconds) taken if an interval is not set, this one processing period is long. By setting an interval, however, I/O wait time is reduced and entire processing time is shortened.

The entire processing time is approximately equal to total I/O time. The total I/O time is (I/O processing time+I/O wait time). Processing time per I/O access is 30 milliseconds and wait time is 45 milliseconds (=(0.6/(1−0.6))×30 milliseconds). Accordingly, 75 milliseconds elapse after a request for I/O access is made and before the processing is completed.

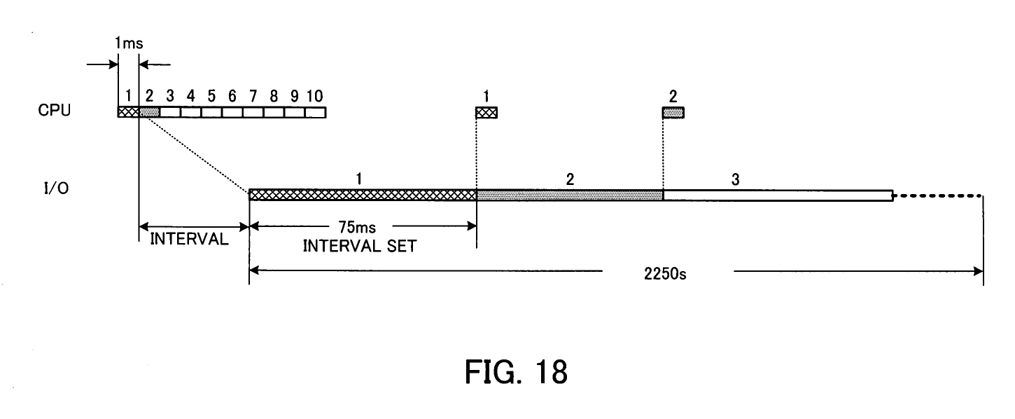

FIG. 18 shows entire processing time taken if an interval is set. In FIG. 18, the relationship between batch processes performed by the CPU and time and the relationship between a batch process in which I/O access is performed and time are shown. The ten batch processes simultaneously performed are numbered from 1 to 10 and a time zone where each batch process is performed is indicated by its number.

75 milliseconds elapse after a request for I/O access is made and before the processing is completed. The batch processing in which I/O access occurs 3,000 times is performed at a multiplicity of 10. Accordingly, the total I/O time is 2,250 seconds (=75 (milliseconds)×3000 (times)×10 (multiplicity)).

This can be written as

$$entire processing time = total I / O time = I / O processing time + I / O wait time = 30 ( milliseconds ) ⨯ ( 1 + ( 0.60 \div ( 1 - 0.60 ) ) ) ⨯ 3000 ( times ) ⨯ 10 ( multiplicity ) = 2250 seconds \qquad ( 12 )$$

As a result, by setting an interval, the entire processing time is reduced from 3,600 seconds to 2,250 seconds. This means that about 37 percent of the I/O load can be reduced.

In this embodiment, as state above, the multiplicity of the batch processing is increased only when margins of processing loads on all of the CPU source, the I/O sources, and the communication sources are left. This enables the server to perform processes at a multiplicity which is most suitable from the viewpoint of processing efficiency.

In addition, if a processing load caused by I/O processing or communication processing exceeds an upper limit value, a request for I/O processing or communication processing is outputted after the elapse of an interval. By adjusting this interval, a load caused by I/O processing can be reduced and the processing efficiency of the entire system can be improved.

If the load on the CPU resource exceeds the upper limit value, a multiplicity should be decreased. By doing so, the processing load on the CPU resource can be reduced.

The above functions can be realized with a computer. In this case, a program in which the contents of the functions the load control apparatus should have are described is provided. By executing this program on the computer, the above functions are realized on the computer. This program can be recorded on a computer readable record medium. A computer readable record medium can be a magnetic recording device, an optical disk, a magneto-optical recording medium, a semiconductor memory, or the like. A magnetic recording device can be a hard disk drive (HDD), a flexible disk (FD), a magnetic tape, or the like. An optical disk can be a digital versatile disk (DVD), a digital versatile disk random access memory (DVD-RAM), a compact disk read only memory (CD-ROM), a compact disk recordable (CD-R)/rewritable (CD-RW), or the like. A magneto-optical recording medium can be a magneto-optical disk (MO) or the like.

To place the program on the market, portable record media, such as DVDs or CD-ROMs, on which it is recorded are sold. Alternatively, the program is stored in advance on a hard disk in a server computer and is transferred from the server computer to another computer via a network.

When the computer executes this program, it will store the program, which is recorded on a portable record medium or which is transferred from the server computer, on, for example, its hard disk. Then the computer reads the program from its hard disk and performs processes in compliance with the program. The computer can also read the program directly from a portable record medium and perform processes in compliance with the program. Furthermore, each time the program is transferred from the server computer, the computer can perform processes in turn in compliance with the program it receives.

The present invention is not to be construed as limited to the above embodiment. Various other modifications and changes can be made without departing from the spirit and scope of the present invention.

In the present invention, when the multiplicity of processing is increased, loads on the CPU resource and all of the other resources do not exceed the upper limit values. As a result, when the multiplicity of the processing is increased, processing loads on all of the resources on the server do not become excessive and the processing can be performed at a multiplicity which is most suitable from the viewpoint of processing efficiency.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A load control apparatus for controlling a load on a server which performs multiplex processing, the apparatus comprising:
a load information acquisition section for acquiring load information regarding loads on a CPU resource and other resources on the server;
a multiplicity determination section for calculating, on the basis of the load information, an increase in load on each resource caused by increasing a multiplicity of a process which is being performed by the server, and for determining, on the basis of the load information, a multiplicity by which a load on each of all the resources becomes smaller than or equal to an upper limit value set in advance; and
a multiplicity control section for changing the multiplicity of the process which is being performed by the server to the multiplicity determined by the multiplicity determination section.

2. The load control apparatus according to claim 1, wherein when a plurality of processes are being performed by the server, the multiplicity determination section selects each process in order as an object for an examination of an increase in multiplicity and determines whether the multiplicity of a selected process can be increased.

3. The load control apparatus according to claim 2, wherein the multiplicity determination section repeats the selection of a process as an object for an examination of an increase in multiplicity until it becomes impossible to increase the multiplicity of any of the plurality of processes.

4. The load control apparatus according to claim 2, wherein:
a maximum multiplicity of each of the plurality of processes which are being performed by the server is set in advance; and
the multiplicity determination section excludes a process which has reached the maximum multiplicity from the examination of an increase in multiplicity.

5. The load control apparatus according to claim 1, wherein the multiplicity determination section selects only a batch process from among processes which are being performed by the server and determines the multiplicity of the batch process.

6. The load control apparatus according to claim 1, further comprising:
an interval determination section for determining on the basis of the load information whether loads on the other resources are greater than upper limit values, and for calculating, in the case of the loads on the other resources being greater than the upper limit values, intervals corresponding to the other resources; and
an interval control section for giving the server instructions to output requests for processing to the other resources after the elapse of the intervals.

7. A load control program for controlling a load on a server which performs multiplex processing, the program making a computer function as:
a load information acquisition section for acquiring load information regarding loads on a CPU resource and other resources on the server;
a multiplicity determination section for calculating, on the basis of the load information, an increase in load on each resource caused by increasing a multiplicity of a process which is being performed by the server, and for determining, on the basis of the load information, a multiplicity by which a load on each of all the resources becomes smaller than or equal to an upper limit value set in advance; and
a multiplicity control section for changing the multiplicity of the process which is being performed by the server to the multiplicity determined by the multiplicity determination section.

8. A method for controlling a load on a server which performs multiplex processing with a computer, the method comprising the steps of:
acquiring load information regarding loads on a CPU resource and other resources on the server;
calculating, on the basis of the load information, an increase in load on each resource caused by increasing a multiplicity of a process which is being performed by the server, and determining, on the basis of the load information, a multiplicity by which a load on each of all the resources becomes smaller than or equal to an upper limit value set in advance; and
changing the multiplicity of the process which is being performed by the server to the multiplicity determined.
